(19) United States
(12) Patent Application Publication
(10) Pub. No.: US 2026/0289568 A1
(43) Pub. Date: Sep. 24, 2026

(54) STACKING OF HETEROGENEOUS MACHINE LEARNING MODELS FOR DETECTION OF FRAUDULENT TRANSACTIONS

(71) Applicant: ACTIMIZE LTD., Ra'anana (IL)

(72) Inventors: Saurab GODSE, Pune (IN); Ankush SHRIKHANDE, Pune (IN); Amol KOKATE, Pune Maharashtra (IN)

(21) Appl. No.: 19/084,125

(22) Filed: Mar. 19, 2025

(51) Int. Cl. G06Q 20/40; G06N 20/00

(52) U.S. Cl. CPC G06Q 20/4016; G06N 20/00

(57) ABSTRACT

A system is adapted to automatically detect fraudulent transactions. The system includes a fraud management computer system programmed for: receiving a plurality of transactions, some legitimate and some fraudulent; with the transactions and a K-fold training module, training a heterogeneous group of machine learning models to classify the transactions as legitimate or fraudulent, where the K-fold training module generates, for each machine learning model, a mean and a standard deviation; with the means and standard deviations, determining a weight for each machine learning model; and, with the weights for each machine learning model, defining a meta machine learning model to classify the transactions as legitimate or fraudulent; receiving a real-time transaction and, with the trained machine learning models, generating determinations of whether it is legitimate or fraudulent; with the meta machine learning model and the determinations, classifying the real-time transaction as legitimate or fraudulent; and, if fraudulent, generating an alert.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The subject matter described herein relates to a devices, systems, and methods for combining machine learning models of diverse types. This stacked heterogeneous machine learning model has particular but not exclusive utility for detecting fraudulent financial transactions.

### BACKGROUND

Detection of fraudulent transactions often involves using machine learning models to analyze each incoming transaction for suspicious characteristics such as a larger than usual dollar amount, or a beneficiary in an unusual location. In an example, many current fraud detection systems rely heavily on an XGBoost algorithm. However, diverse algorithm types are available for such analysis, each with its own advantages and disadvantages. When multiple models are used, and results differ between different algorithms, it can be difficult to know which one to trust, or how to combine their results. A voting/averaging approach treats all algorithms equally. Thus, existing fraud detection methods that rely on standalone machine learning models may miss evolving fraud tactics. Accordingly, a need exists for improved machine learning methods that address the foregoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a stacked heterogeneous machine learning model which calculates relative weighting to combine the outputs of multiple machine learning models of different types into a single meta model that exhibits a higher classification accuracy and lower standard deviation than any of the individual models. The stacked heterogeneous machine learning model disclosed herein has particular, but not exclusive, utility for identification of fraudulent financial transactions.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically detect fraudulent transactions. The system includes a fraud management computer system having a processor and a non-transitory computer readable medium operably coupled thereto, the fraud management computer system including a transactions database, the non-transitory computer-readable medium including a plurality of instructions stored in association therewith that are accessible to, and executable by, the processor, to perform operations which may include: over a first period of time, with the transactions database, receiving a plurality of transactions, each transaction including a plurality of features, where some of the transactions are legitimate and some of the transactions are fraudulent; with the plurality of transactions and a k-fold training module, training a heterogeneous plurality of machine learning models to classify the transactions as legitimate or fraudulent, where each machine learning model of the heterogeneous plurality of machine learning models is of a different type than other machine learning models of the heterogeneous plurality of machine learning models, where each respective machine learning model of the heterogeneous plurality of machine learning models generates a respective weight for each feature of the plurality of features; where the k-fold training module generates, for each respective machine learning model of the heterogeneous plurality of machine learning models, a mean and a standard deviation, where the mean and the standard deviation are of precision values or variability values of the respective machine learning model; with the mean and the standard deviation for each respective machine learning model of the heterogeneous plurality of machine learning models, determining a weight of the respective machine learning model; with the weights for each respective machine learning model, and the classifications made by each respective machine learning model, defining a meta machine learning model to classify the transactions as legitimate or fraudulent; receiving a real-time transaction; with the trained machine learning models of the heterogeneous plurality of machine learning models, generating a plurality of determinations of whether the real-time transaction is legitimate or fraudulent; with the meta machine learning model and the plurality of determinations, classifying the real-time transaction as legitimate or fraudulent; and if the real-time transaction is fraudulent, generating an alert for the real-time transaction; and displaying the alert to a user. Other embodiments of this aspect include corresponding computer systems, apparatus, and computer programs recorded on one or more computer storage devices, each configured to perform the actions of the methods.

Implementations may include one or more of the following features. In some embodiments, the operations further may include, with the weights of the respective features for each respective machine learning model of the heterogeneous plurality of machine learning models, and the weights of the respective machine learning models, determining a contribution of each feature of the plurality of features to the classification made by the meta machine learning model. In some embodiments, determining the weight of the respective machine learning model involves minimizing a log-loss of the meta machine learning model. In some embodiments, the heterogeneous plurality of machine learning models includes at least one of a random forest model, a Naïve Bayes model, a support vector machine, a gradient boosting model, an Adaboost model, a K-Nearest-Neighbor model, an XGboost model, a classification and regression tree (CART) model, or a decision tree model. In some embodiments, the heterogeneous plurality of machine learning models is selected from a larger plurality of machine learning models. In some embodiments, the selection is a selection of machine learning models of the larger plurality that have higher accuracy than an average accuracy of the larger plurality of machine learning models in making the plurality of determinations of whether the real-time transaction is legitimate or fraudulent. In some embodiments, the accuracy is determined by an area-under-curve (AUC), F1, detection rate, or value detection rate, or a combination thereof. In some embodiments, the heterogeneous plurality of machine learning models may include at least five (5) machine learning models. In some embodiments, the operations further may include performing at least one of data filtration, data cleaning, exploratory data analysis, fraud enrichment, feature engineering, or feature selection for the plurality of transactions, or a combination thereof. In some embodiments, the K-fold training module uses five (5) folds. Implementations of the described techniques may include hardware, a method or process, or computer software on a computer-accessible medium.

One general aspect includes a computer-implemented method. The computer-implemented method includes, over a first period of time, with the transactions database, receiving a plurality of transactions, each transaction including a plurality of features, where some of the transactions are legitimate and some of the transactions are fraudulent; with the plurality of transactions and a K-fold training module, training a heterogeneous plurality of machine learning models to classify the transactions as legitimate or fraudulent, where each machine learning model of the heterogeneous plurality of machine learning models is of a different type than other machine learning models of the heterogeneous plurality of machine learning models, where each respective machine learning model of the heterogeneous plurality of machine learning models generates a respective weight for each feature of the plurality of features; where the K-fold training module generates, for each respective machine learning model of the heterogeneous plurality of machine learning models, a mean and a standard deviation, where the mean and the standard deviation are of precision values or variability values of the respective machine learning model; with the mean and the standard deviation for each respective machine learning model of the heterogeneous plurality of machine learning models, determining a weight of the respective machine learning model; with the weights for each respective machine learning model, and the classifications made by each respective machine learning model, defining a meta machine learning model to classify the transactions as legitimate or fraudulent; receiving a real-time transaction; with the trained machine learning models of the heterogeneous plurality of machine learning models, generating a plurality of determinations of whether the real-time transaction is legitimate or fraudulent; with the meta machine learning model and the plurality of determinations, classifying the real-time transaction as legitimate or fraudulent; and if the real-time transaction is fraudulent, generating an alert for the real-time transaction; and displaying the alert to a user. Other embodiments of this aspect include corresponding computer systems, apparatus, and computer programs recorded on one or more computer storage devices, each configured to perform the actions of the methods.

Implementations may include one or more of the following features. In some embodiments, the computer-implemented method may include: with the weights of the respective features for each respective machine learning model of the heterogeneous plurality of machine learning models, and the weights of the respective machine learning models, determining a contribution of each feature of the plurality of features to the classification made by the meta machine learning model. In some embodiments, determining the weight of the respective machine learning model involves minimizing a log-loss of the meta machine learning model. In some embodiments, the heterogeneous plurality of machine learning models includes at least one of a random forest model, a Naïve Bayes model, a support vector machine, a gradient boosting model, an Adaboost model, a K-nearest-neighbor model, an XGboost model, a classification and regression tree (CART) model, or a decision tree model. In some embodiments, the heterogeneous plurality of machine learning models is selected from a larger plurality of machine learning models. In some embodiments, the selection is a selection of machine learning models of the larger plurality that have higher accuracy than an average accuracy of the larger plurality of machine learning models in making the plurality of determinations of whether the real-time transaction is legitimate or fraudulent. In some embodiments, the accuracy is determined by an area-under-curve (AUC), F1, detection rate, or value detection rate, or a combination thereof. In some embodiments, the heterogeneous plurality of machine learning models may include at least five (5) machine learning models. In some embodiments, the computer-implemented method may include: performing at least one of data filtration, data cleaning, exploratory data analysis, fraud enrichment, feature engineering, or feature selection for the plurality of transactions, or a combination thereof. In some embodiments, the K-fold training module uses five (5) folds. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the stacked heterogeneous machine learning model, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation, in block diagram form, of an example fraud management system, in accordance with at least one embodiment of the present disclosure.

FIG. 2 is a schematic diagram of a processor circuit, according to embodiments of the present disclosure.

FIG. 3 is a schematic, diagrammatic representation of an integrated fraud management (IFM) system that incorporates the stacked heterogeneous machine learning model, in accordance with at least one embodiment of the present disclosure.

FIG. 4 is a schematic, diagrammatic representation, in block diagram form, of an example integrated fraud management software architecture, in accordance with at least one embodiment of the present disclosure.

FIG. 5 is a diagrammatic representation of a machine learning model stacking process, in accordance with at least one embodiment of the present disclosure.

FIG. 6 is a schematic, diagrammatic representation of a stacked heterogeneous machine learning model training, testing, and inference process, in accordance with at least one embodiment of the present disclosure.

FIG. 7 is a schematic, diagrammatic representation, in block diagram form, of a stacked heterogeneous machine learning model training process, in accordance with at least one embodiment of the present disclosure.

FIG. 8 is a schematic, diagrammatic representation, in block diagram form, of a machine learning model selection process, in accordance with at least one embodiment of the present disclosure.

FIG. 9 is a schematic, diagrammatic representation, in flow diagram form, of an example K-fold cross-validation process, in accordance with at least one embodiment of the present disclosure.

FIG. 10 is a schematic, diagrammatic representation of a stacked heterogeneous machine learning model, in accordance with at least one embodiment of the present disclosure.

FIG. 11 shows a flow diagram of an example stacked heterogeneous machine learning method according to at least one embodiment of the present disclosure.

FIG. 12 is a schematic, diagrammatic representation, in block diagram form, of an example transaction flow, in accordance with at least one embodiment of the present disclosure.

FIG. 13 is a schematic, diagrammatic representation of an alert prioritization flow, in accordance with at least one embodiment of the present disclosure.

FIG. 14 is a schematic, diagrammatic representation of a transaction response selection in a production environment, in accordance with at least one embodiment of the present disclosure.

### DETAILED DESCRIPTION

In accordance with at least one embodiment of the present disclosure, a stacked heterogeneous machine learning model is provided which calculates relative weighting to combine the outputs of multiple heterogeneous machine learning models (also known as base models or Level 0 models) into a single meta model (also known as an ensemble model, stacked model, or Level 1 model) that exhibits a higher classification accuracy and lower standard deviation than any of the individual base models.

The disclosed approach involves the insights from multiple machine learning algorithms, ultimately boosting the overall fraud detection performance. Integrating multiple machine learning algorithms into the fraud detection process tackles the problem using methods described below. A meta model architecture involves two or more base models, often referred to as Level 0 models, and a meta-model that combines the predictions of the base models, referred to as a Level 1 model. Level 0 models (also known as base models) are models fit on the training data and whose predictions are compiled. The Level 1 model (also known as a meta model, ensemble model, or stacked model) is a model that learns how to best combine the predictions of the base models. The meta-model is trained on the predictions made by base models on out-of-sample data. Container-based deployment may be used for meta-model implementation.

A heterogeneous collection of model types may be selected to provide a desired level of diversity to the predictions made. Decisions from multiple algorithms help the system to identify additional frauds which may not be identified by the base models individually. This approach helps by saving a significant amount of money in fraud losses for the customers, by catching frauds that would otherwise go undetected by single machine learning algorithms.

Data Collection: The data essential for fraud analysis may originate for example from Amazon S3, or any other secure and scalable object storage service where a wealth of customer information may be housed, encompassing a diverse range of data types. This includes static customer data, such as demographic details and contact information; historical behavioral profiles, which capture past interactions and preferences; and recent transaction data, providing insights into current patterns. In an example, training data may incorporate around 6 months of data for Web automated clearinghouse (ACH) Retail transactions. In order to handle the large database, a Bernouli sampling method may be used, where each element of the population is subjected to an independent Bernoulli trial which determines whether the element becomes part of the sample. In such a sampling, every member of the population may have the same probability of selection. Training is accomplished through a multi-step process as described below.

Customer Data Availability and Extraction: a possible first step is to identify all tenants from the same base activity. To conduct analysis, data is extracted from an Integrated Fraud Management (IFM) database, typically spanning a timeframe of 3 to 6 months. This extraction is based on a common characteristic known as “base activities.” Base activities such as “Web ACH Retail” are essentially groupings of events within client systems, serving as a logical framework for profiling and detection purposes. The data necessary for analysis may be sourced from S3, where information from various customers is stored. This data undergoes a filtering process to extract relevant information based on specific criteria. For example, to enhance the sophistication of the base models, the system may prioritize the use of recent data shared by customers. This recent transaction data is augmented with transaction attributes computed by a platform for financial crime prevention, to create a comprehensive dataset for model development analysis. This dataset can serve as the foundation for developing advanced analytics.

The process involves gathering data from various sources, extracting relevant information based on predefined criteria, including a comprehensive set of features for model development, and applying filtering rules to streamline transaction processing before model evaluation. This approach ensures that the machine learning models are trained on a robust dataset, optimizing their effectiveness in fraud detection and prevention. The quality of input data and the accuracy of data processing may be important for building high-quality models. To achieve this, data cleaning procedures may be employed to eliminate any unreliable or inconsistent data. Additionally, certain input data may require transformation into numerical values to facilitate their incorporation into the final model equation. Transactions that have undergone a filtering process and are deemed unnecessary for model development may be excluded from consideration. Filters, in this context, represent technical rules or business rules applied to evaluate incoming transactions. The purpose of these filter rules is to streamline transaction processing by determining whether a transaction requires further assessment by a machine learning model.

To maintain the integrity of the model development process, quality control (QC) or data validation checks may be performed on the dataset. These checks aim to identify any anomalies or issues that could potentially compromise the quality of the model. Any issues detected during the data gathering phase are addressed promptly to ensure the robustness and reliability of the model. Utilization of recent data combined with secondary or derived attributes allows for the creation of more advanced models. Ensuring data quality through cleaning procedures and validation checks may be essential for developing accurate and reliable fraud detection models.

One optional step involves identifying and handling missing values within the dataset. Missing values can adversely affect model performance, so techniques like imputation (filling missing values with estimated ones) or deletion (removing rows or columns with missing values) may be applied. Features with zero variance, meaning they have constant values across all samples, may also be identified and removed from the dataset, as they do not contribute any meaningful information to the model and can be safely dropped. Features with having large numbers of categories (e.g., a default threshold of 50 categories) may also be identified and removed from the dataset, as such high-cardinality features can create a large number of dummy variables and reduce model performance. Features that are specific to certain tenants or regions and do not generalize well across the dataset may also be dropped. This helps ensure that the model remains robust and applicable to diverse data scenarios. The system can also check the fraud distribution across different time periods to ensure sufficient fraud availability for model training.

After data cleaning, the system may analyze the feature distribution for each variable using below information. For numerical features, this may involve calculating a min, max, mean, standard deviation, and/or distinct count. For categorical features, this may involve determining a fraud rate and legit rate for each categorical feature. Lift analysis may also be employed. Lift analysis is a powerful technique to measure the effectiveness of each individual variable on a target variable (e.g., fraud yes/no). The system may have separate lift analysis for categorical features and numerical features, and numerical features may be binned prior to lift analysis. Next, a Characteristic Stability Index (CSI) measures the degree of change in the distribution between two datasets. This analysis helps the system to measure feature stability across different time periods, and to drop features with stability below a defined threshold.

Next, fraud enrichment augments data with additional fraud labels obtained from existing information related to fraudulent transactions. This is achieved by rectifying mislabeled transactions that were erroneously tagged as legitimate instead of fraudulent by bank analysts. In fraud detection, having more data on fraudulent activities enhances the accuracy of risk calculations. Fraud enrichment may be carried out based on an analysis of transactions closely associated with fraudulent ones, typically determined by certain business logic metrics, such as transactions involving the same payee entity. Legitimate transactions occurring within a day before or after a fraudulent transaction from the same device key may be labeled as enriched fraud. Legitimate transactions involving the same payee entity as a fraudulent transaction may be labeled as enriched fraud. Legitimate transactions linked to the same party key as fraudulent transactions from the same device key may be labeled as enriched fraud. After fraud enrichment, the system may need to validate the results of the fraud enrichment and ensure that unnecessary frauds have not been added to the original datasets, to avoid noise which may impact model performance.

Next, feature engineering and feature selection may be performed. Date duration is the difference between two date columns, where one date column is always used for reference and is the date at which the transaction happened. A weekdays/weekend feature may calculate whether the date column falls on a weekday or weekend day. A derived time bucket for the transaction determines whether the transaction happens in the morning, afternoon, evening or night. A ratio between two features sometimes provides greater insight than the two features by themselves. One hot encoding creates new (binary) columns, indicating the presence of each possible value from the original categorical data. Log transformation replaces each variable with its logarithm, which can be helpful to make feature distribution more symmetric and reduce skewness.

Feature selection may be based on one or more of the following methods: a feature importance list from a baseline XGBoost model can identify which features are significant for the model. A Boruta algorithm allows the system to create a ranking of features, from the most impactful to the least impactful for the model. Min-Redundancy Max-Relevance is an algorithm that ranks features based on their importance in predicting the target variable, where importance has a relevance and redundancy component. In some cases, the final list of features may be reviewed and edited by a subject matter expert (SME), although this may not be necessary for high-performing feature selection algorithms.

Data preprocessing may include splitting data into two distinct subsets: a training set and a test set. This partitioning ensures that the model is trained on one subset and evaluated on another, thus allowing for an unbiased assessment of its performance. When dealing with imbalanced datasets, such as those common in fraud detection where fraudulent transactions are sparse compared to legitimate ones, a careful sampling strategy may be employed. In an example, all fraudulent observations are retained, while only a subset of legitimate observations are sampled. This helps ensure that the model receives sufficient exposure to fraudulent instances during training. The training set is used to build and train the predictive model, while the test set serves as an independent dataset for evaluating the model's performance. By training the model on one subset and testing it on another, we can assess its ability to generalize to unseen data. Typically, the dataset is divided into an 80% training set and a 20% test set. This ratio is commonly used in machine learning experiments. Notably, it may be important to ensure that the training data precedes the test data chronologically, to prevent any potential data leakage, especially in domains like finance where temporal order may be crucial. This approach helps in evaluating the model's robustness and its ability to make accurate predictions on new, unseen instances.

Multiple models are trained on the training data set. Then, based on the accuracy of individual models, the 5 top-performing models are selected. These models are then used for stacking. For accuracy comparison, the system may use business metrics like detection rate (DR) and value detection rate (VDR), along with other statistical metrics like precision, AUC and F1 score, to analyze model performance. The final score is then calculated as described below.

K-fold cross validation in machine learning is a powerful technique for evaluating predictive models. It involves splitting the dataset into k subsets or folds, where each fold is used as the validation set in turn while the remaining k−1 folds are used for training. This process is repeated k times, and performance metrics such as accuracy, precision, and recall are computed for each fold. By averaging these metrics, the system can obtain an estimate of the model's generalization performance. K-fold cross-validation is computationally efficient and widely used in practice. For the Level 0 model (e.g., an ensemble of base models), each classifier is trained and tested on different folds of the data. In an example, five different classifiers are trained: a) Random Forest (RF) b) Naïve Bayes (NB) c) Support Vector Machine (SVM) d) Gradient Boosting (GB) e) AdaBoost. The output of test results from each classifier is collected.

The Level 1 model is the main production model, which integrates various components. The meta model is a higher-level model that combines the outputs of the different machine learning models (e.g., Random Forest, Logistic Regression, SVM) to make the final prediction. The classifier model is the core model responsible for the primary prediction task. In an example, a logistic regression model may serve as the Level 1 model or final classifier.

The present disclosure aids substantially in the combination of multiple machine learning models, by improving the ability to calculate weights for each respective model, and preferably, more accurate weights to achieve the best detection of fraudulent transactions. Implemented on a fraud management computing system in communication with a transactions database, the stacked heterogeneous machine learning model disclosed herein provides practical, measurable improvements in the detection of fraudulent transactions. This improved methodology transforms the outputs of multiple machine learning models into a single prediction or classification for each new transaction, without the normally routine need to average or vote the individual outputs. This unconventional approach improves the functioning of the fraud management computing system, by improving the accuracy with which it can identify fraudulent transactions.

The stacked heterogeneous machine learning model may be implemented as a process at least partly viewable on a display, and operated by a control process executing on a processor that accepts user inputs from a keyboard, mouse, or touchscreen interface, and that is in communication with one or more databases. In that regard, the control process performs certain specific operations in response to different inputs or selections made at different times. Certain outputs of the stacked heterogeneous machine learning model may be printed, shown on a display, or otherwise communicated to human operators. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the stacked heterogeneous machine learning model. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one of ordinary skill in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

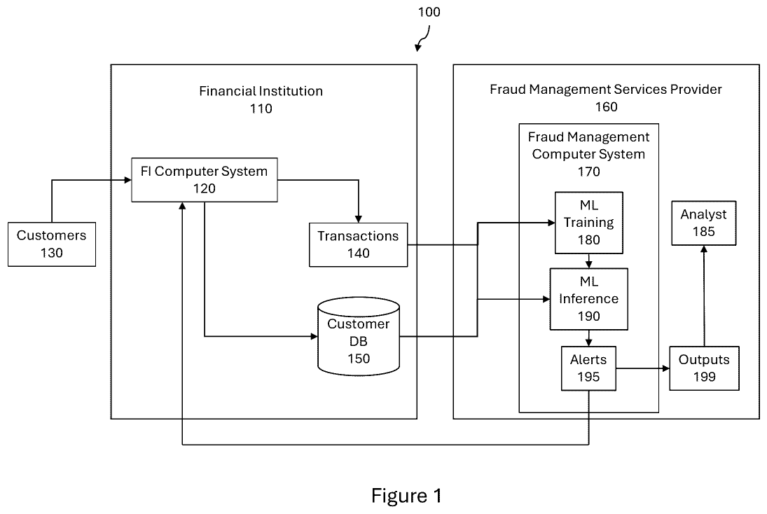

FIG. 1 is a schematic, diagrammatic representation, in block diagram form, of an example fraud management system 100, in accordance with at least one embodiment of the present disclosure. The fraud management system 100 includes a financial institution (FI) 110 and a fraud management services provider 160. At the financial institution, customers 130 interact with an FI computer system 120 to generate transactions 140 and customer data 150. Within the fraud management services provider 160, the transactions 140 and customer data 150 are received by a machine learning model training system 180 running on a fraud management computer system 170. The trained machine learning model(s) are then used in an inference step 190 to categorize new transactions 130 as either legitimate or fraudulent. Fraudulent transactions generate alerts 195, which are sent as outputs 199 to a fraud analyst 185.

Before continuing, it should be noted that the examples described above are provided for purposes of illustration, and are not intended to be limiting. Other devices and/or device configurations may be utilized to carry out the operations described herein. Block diagrams are provided herein for exemplary purposes; a person of ordinary skill in the art will recognize myriad variations that nonetheless fall within the scope of the present disclosure. For example, any of the blocks described herein may optionally include an output to a user of information relevant to the block, and may thus represent an improvement in the user interface over existing art by providing information (whether static or dynamically updated) that is not otherwise available.

Similarly, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

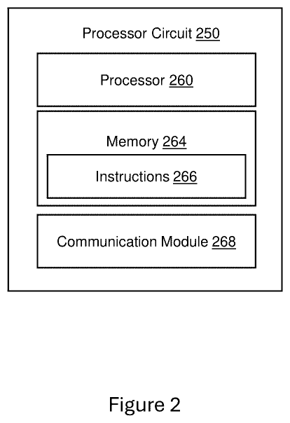

FIG. 2 is a schematic diagram of a processor circuit 250, according to embodiments of the present disclosure. The processor circuit 250 may be implemented in the system 100, or other devices or workstations (e.g., third-party workstations, network routers, etc.), or on a cloud processor or other remote processing unit, as necessary to implement the method. As shown, the processor circuit 250 may include a processor 260, a memory 264, and a communication module 268. These elements may be in direct or indirect communication with each other, for example via one or more buses.

The processor 260 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 260 may also comprise another hardware device, a firmware device, or any combination thereof configured to perform the operations described herein. The processor 260 may also be implemented as a combination of computing devices, e.g., a combination of a DSP and a microprocessor, a plurality of microprocessors, one or more microprocessors in conjunction with a DSP core, or any other such configuration.

The memory 264 may include a cache memory (e.g., a cache memory of the processor 260), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 264 includes a non-transitory computer-readable medium. The memory 264 may store instructions 266. The instructions 266 may include instructions that, when executed by the processor 260, cause the processor 260 to perform the operations described herein. Instructions 266 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 268 can include any electronic circuitry and/or logic circuitry to facilitate direct or indirect communication of data between the processor circuit 250, and other processors or devices. In that regard, the communication module 268 can be an input/output (I/O) device. In some instances, the communication module 268 facilitates direct or indirect communication between various elements of the processor circuit 250 and/or the system 100. The communication module 268 may communicate within the processor circuit 250 through numerous methods or protocols. Serial communication protocols may include but are not limited to United States Serial Protocol Interface (US SPI), Inter-Integrated Circuit (I2C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, etc.) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

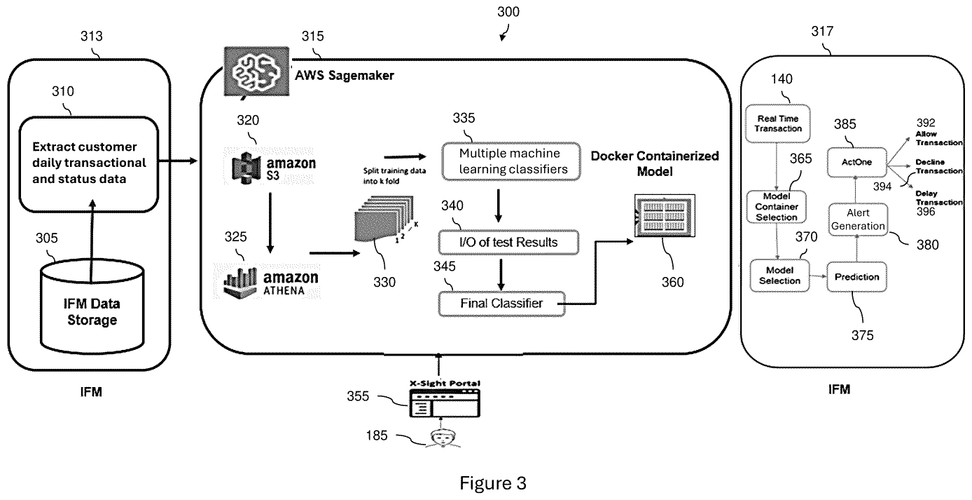

FIG. 3 is a schematic, diagrammatic representation of an integrated fraud management (IFM) system 300 that incorporates the stacked heterogeneous machine learning model, in accordance with at least one embodiment of the present disclosure. This IFM system represents the heart of the fraud management system 100, an umbrella term encompassing all the tools and processes described herein working together to combat fraud. It acts as a central hub, orchestrating data collection, analysis, and response to suspicious activity.

In a first step 310 within a first IFM block 313, the system extracts customer daily transactions and status data from an IFM data storage database 305.

Within a fraud detection block 315, this data is then passed to a storage service 320. The data may include:

Customer Static Data: This encompasses relatively unchanging information about the customer, such as:
Name
Address
Contact details (phone number, email)
Account history (account opening date, account type)
Product subscriptions (credit cards, debit cards, loans)
Preferred banking channels (online banking, mobile app, branch visits)

Transaction Data: This captures a detailed record of each customer interaction, including:
Transaction type (debit, credit, transfer)
Amount
Timestamp (date and time of transaction)
Location (physical branch, ATM, online platform)
Merchant details (for card transactions—name, location)
Device information (IP address, operating system, device type for online/mobile transactions)

### Extracting Daily Customer Static and Transaction Data:

Block 310 plays a fundamental role in the IFM system 300. It's the initial step where the system gathers the raw materials needed to build fraud detection models and analyze future transactions. The data that is extracted includes customer static data and transaction data. This data is sent to later blocks for further processing.

Data received from the IFM database 305 is stored securely in the storage service 320 (e.g., in Amazon S3) and is ready for analysis with a query service (e.g., Amazon Athena). Amazon S3. S3 is a scalable and cost-effective object storage service offered by Amazon Web Services (AWS). It acts as a central repository for the data, making the data readily accessible for further processing. Amazon Athena is an interactive query service, another AWS offering. It allows analysts to directly query the data stored in S3 using standard SQL language. This eliminates the need to set up and manage a separate database, making data exploration and analysis efficient.

In the next step, the system identifies the base activity for which it needs to create models. Base activities represent the most specific activity the customer performed and determine which detection models are calculated for a transaction. Each transaction is mapped to one and only one base activity. The solution calculates a base activity for each transaction. This default base activity is usually determined according to the channel and the transaction type, as well as additional fields and calculations.

In a data splitting step 330, the data queried from the querying service 325 is split into K folds, as described below, and passed to a training system 335 to train multiple Level 0 machine learning classifiers. Test results 340 from the multiple models are then used to train or define (e.g., obtain weights for) a final Level 1 classifier or meta model 345. The models are then containerized (e.g., using Docker) to form a containerized model 360.

Within a real-time inference block 317, a real-time transaction 140 is received. This block represents the incoming data that the system will analyze to identify potential fraud. This data includes details about a customer's transaction, such as the amount, timestamp, location (physical branch, ATM, online platform), merchant details (for card transactions), and device information.

A model container selection block 365 refers to the process of choosing the appropriate machine learning model to assess the incoming transaction. The IFM system 300 stores multiple pre-trained models, and this block selects the most suitable one based on factors like the type of transaction or customer segment. In an example, the final level 1 classifier or meta model 345 is selected.

In a prediction block 375, new real time transactions 140 are fed to the level 1 model classifier for final prediction. In an example, the model outputs a risk score between 0 and 1, where a score closer to 0 suggests a low probability of fraud (likely legitimate transaction), and a score closer to 1 suggests a high probability of fraud (potentially fraudulent transaction). The IFM system uses this fraud probability score to decide whether the transaction is legitimate or suspicious.

Based on the risk score, an alert generation module 380 determines whether to generate an alert, and a policy manager 385 takes one of three actions: either allow the transaction 392, decline the transaction 394, or delay the transaction 396, as discussed below in greater detail.

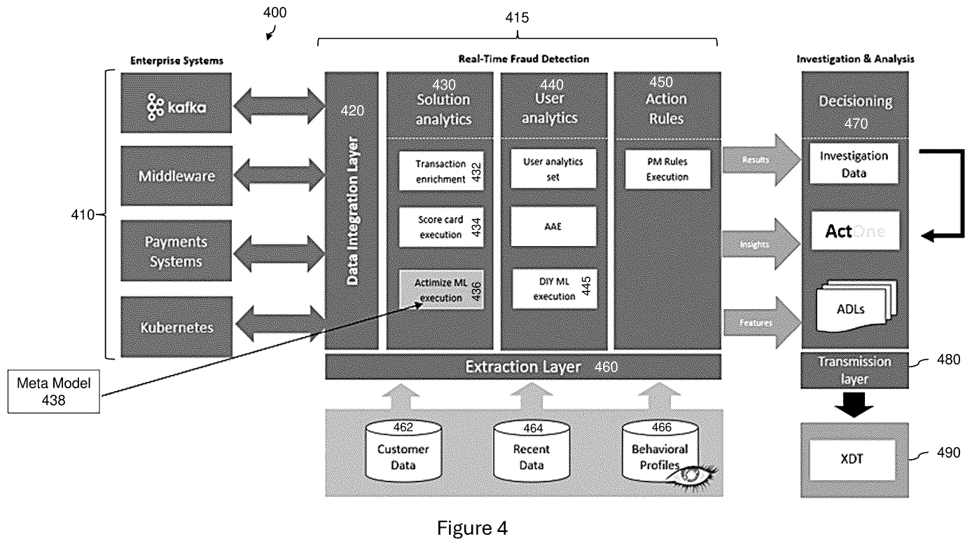

FIG. 4 is a schematic, diagrammatic representation, in block diagram form, of an example integrated fraud management software architecture 400, in accordance with at least one embodiment of the present disclosure. In the example shown in FIG. 4, a collection of enterprise systems 410 may include Apache Kafka (an open-source software platform that manages real-time data streams), middleware, payment systems, and Kubernetes (an open-source software platform that automates the management of containerized applications). These enterprise systems 410 communicate with a real-time fraud detection system 415, which includes a data integration layer 420 that communicates with solution analytics 430, including transaction enrichment 432, score card execution 434, and machine language model execution 436, including execution of the stacked heterogeneous machine learning model or meta model 438 of the present disclosure, in inference mode. Solution analytics communicate with user analytics, including but not limited to do-it-yourself (DIY) machine language model execution 445, which may in some cases execute the stacked heterogeneous machine learning model or meta model 438 of the present disclosure, in inference mode. Action rules 450 determine what investigation and analysis decisioning actions 470 will be taken by the system. Outputs of the decisioning 470 are passed to a transmission layer 480 where they can be viewed or interacted with by a user application 490.

The real-time fraud detection module 415 receives data through an extraction layer 460 from a customer data database 462, a recent data database 464, and a behavioral profiles database 466.

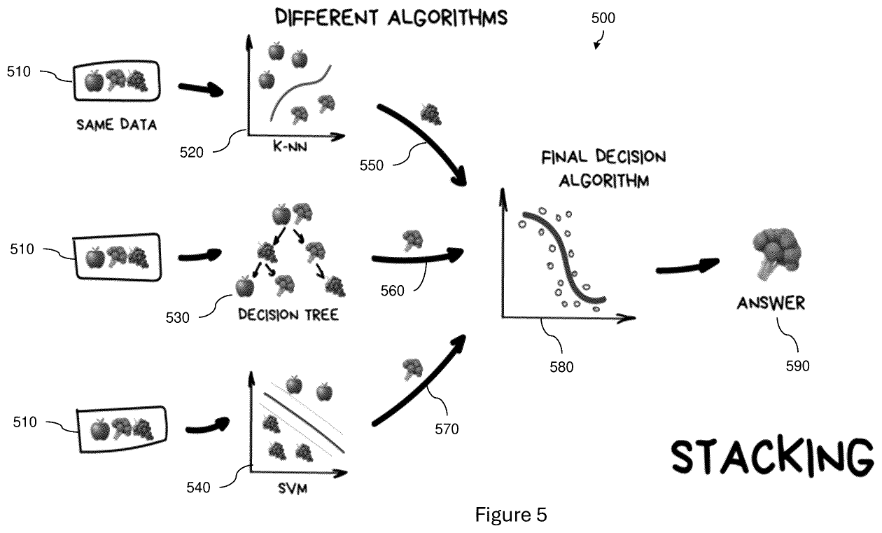

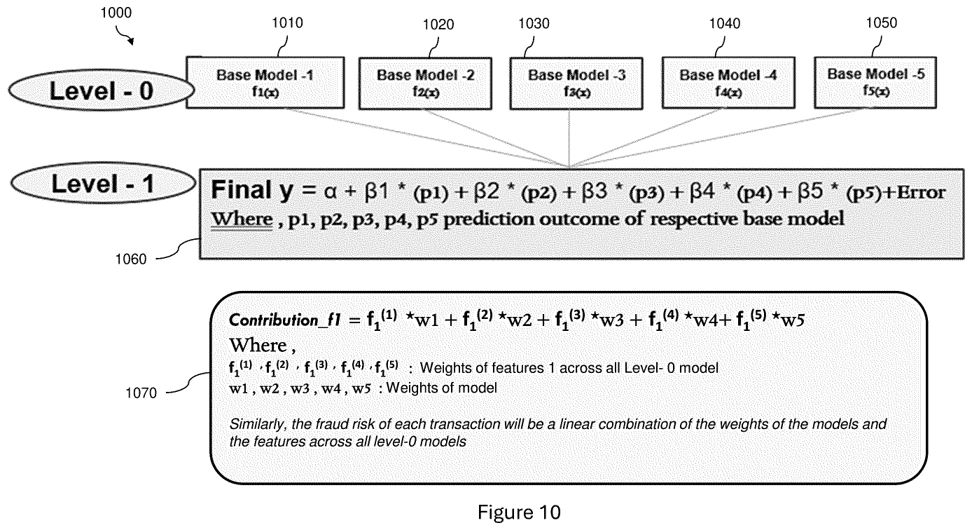

FIG. 5 is a diagrammatic representation of a machine learning model stacking process 500, in accordance with at least one embodiment of the present disclosure. In the example shown in FIG. 5, the same training data 510 is fed to three different trained machine learning models: a K-Nearest Neighbor model 520, a decision tree model 530, and a support vector machine 540. These models produce classification outputs 550, 560, and 570, respectively, which are fed to a final decision algorithm or meta model 580, which produces a final answer 590 based on a weighting of the outputs 550, 560, and 570. Determining how to weight the outputs of dissimilar machine learning models is an object of the present disclosure, and is discussed in more detail in FIG. 10, below.

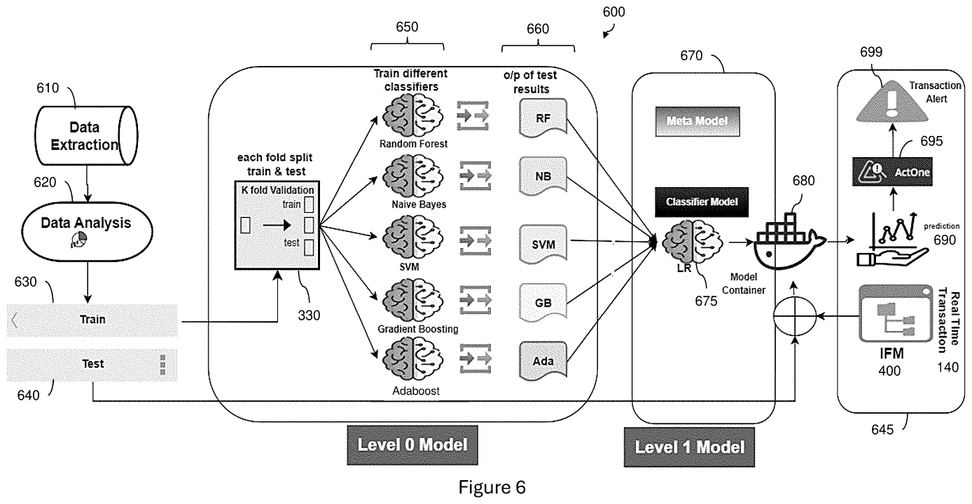

FIG. 6 is a schematic, diagrammatic representation of a stacked heterogeneous machine learning model training, testing, and inference process 600, in accordance with at least one embodiment of the present disclosure. A data extraction block 610 provides data to a data analysis block 620, which then passes at least some of the data to a training block 630, and at least some of the data (e.g., a different subset of the data) to a testing block 640.

The training block 630 employs a K-fold data splitting block 330, which splits the data into K different groups or “folds” (e.g., 5 folds), and uses 4 of the 5 folds for training and one fold for validation, then uses a different 4 of the 5 folds for training a different one fold for validation, and so on until all five folds have been used for validation. The four folds that produce the best overall performance are then used for final training of the model for given machine algorithms.

The output of the K-fold splitting block is a number of trained classifiers 650 (e.g., 5 trained classifiers) of different types. In the example shown in FIG. 6, these are a random forest model, a Naïve Bayes model, a support vector machine, a gradient boosting model, and an Adaboost model. The outputs 660 of the test results from the machine learning models 650 are then fed to a meta model 670, which is trained or otherwise crafted to combine the outputs 660 by assigning weights to each output 660 and then summing the weighted results. The heterogeneous models 650 and the meta model classifier 675 are then containerized into a model container 680.

The test block 640 passes data to the containerized model 680 to determine whether the containerized model 680 produces predictions (e.g., transaction risk scores) that exceed a threshold accuracy (e.g., 75% accuracy). If not, then more or different raining data may be needed, and the training block 630 repeated.

In an inference block 645, the system 600 receives a real-time transaction 140 which is processed by an integrated fraud management system 400. The IFM system 400 passes the transaction to the model container 680 and receives prediction 690, e.g., a risk score between 0 and 1, indicating the likelihood that the transaction is fraudulent. This prediction 690 is then passed to a policy manager 695, which will, if the risk score exceeds a threshold value (e.g., 40%), issue a transaction alert 699.

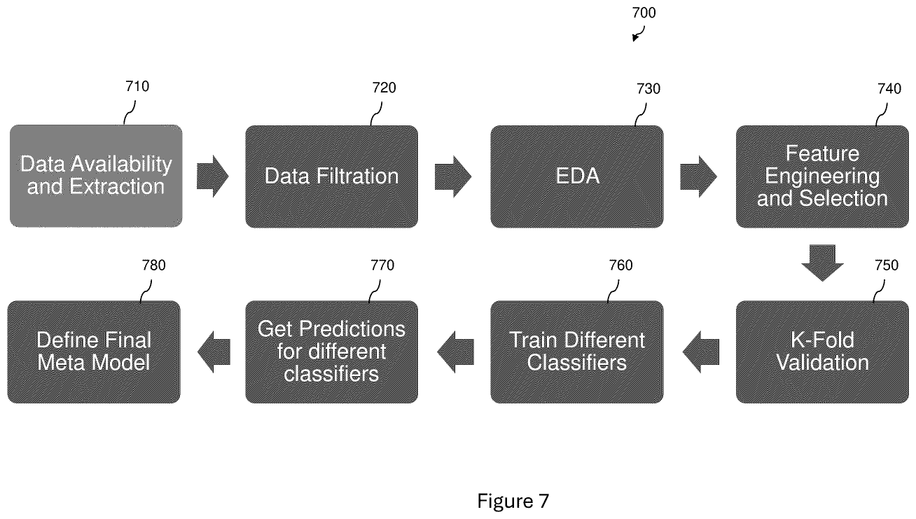

FIG. 7 is a schematic, diagrammatic representation, in block diagram form, of a stacked heterogeneous machine learning model training process 700, in accordance with at least one embodiment of the present disclosure. In a data availability and extraction block 710, data is obtained about past transactions, including static customer data associated with the transactions. In a data filtration step 720, the data is cleaned and filtered as described above. In an exploratory data analysis block 730, the data is analyzed to identify patterns, trends, and anomalies that could inform the model training process. This step involves visualizing the data, summarizing its main characteristics, and performing statistical analysis to understand the relationships between different variables. In a feature engineering and selection block 740, the system determines which features are most influential in determining whether a transaction is fraudulent or legitimate. In a K-fold validation block, the training data (e.g., the transactions, as represented by their most relevant features) is broken into K folds and used, in a training step 760, to train multiple heterogeneous Level 0 classifiers. In a prediction block 770, each of the heterogeneous Level 0 classifiers is used to generate a prediction (e.g., a risk score reflecting the probability that a transaction is fraudulent). Based on these outputs, a final meta model or Level 1 model is defined in block 780, using the method described herein.

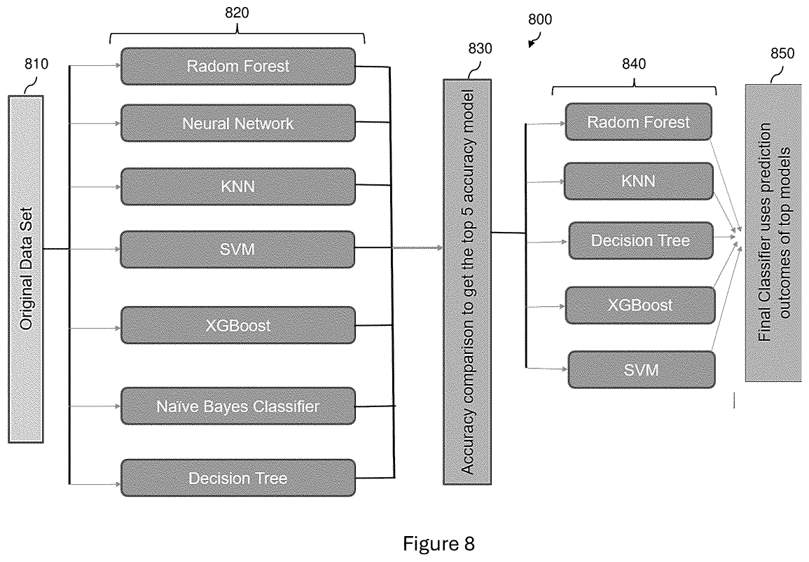

FIG. 8 is a schematic, diagrammatic representation, in block diagram form, of a machine learning model selection process 800, in accordance with at least one embodiment of the present disclosure. In some situations, it may be desirable to see which types of machine learning models do the best job of identifying fraudulent transactions in a data set. Thus, an original data set 810 is used to train a number of machine learning models 820 of different types. In the example shown in FIG. 6, seven different machine learning model types are trained, including a random forest model, a neural network model, a K-Nearest Neighbor model, a support vector machine, an X-Gradient Boost model, a Naïve Bayes Classifier model, and a decision tree model. Other types of models that might be trained include a classification and regression tree (CART) model, an Adaboost model, a logistic regression model, a gradient boosting machine (GBM), or a LightGBM model. In an accuracy comparison block 830, the top N models 820 (e.g., the top 5 models) with the highest accuracy are selected. In the example shown in FIG. 8, five top models 840 are selected, including the random forest model, the K-Nearest Neighbor model, the decision tree model, and XGBoost model, and the support vector machine. In block 850, the final classifier, meta model, or Level 1 model uses the predictions of the top models 840 to arrive at a final prediction or risk score for the transaction.

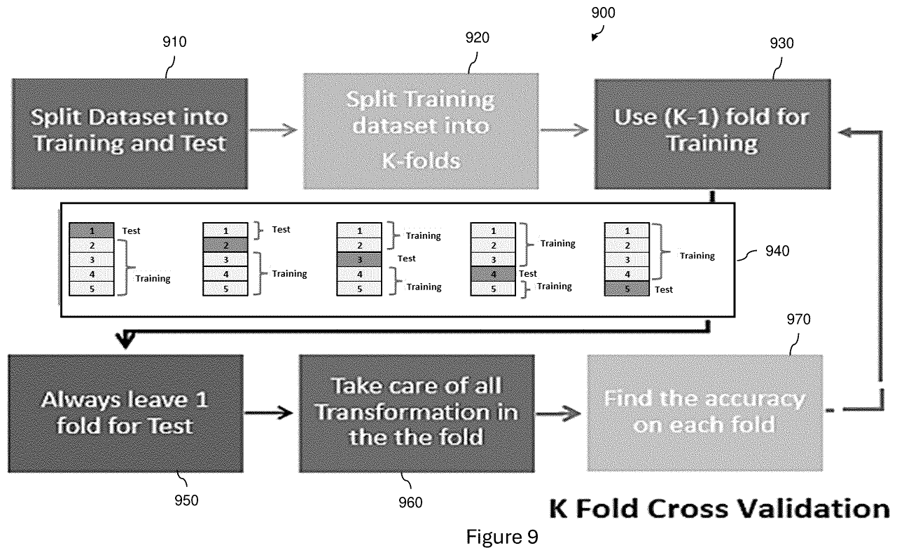

FIG. 9 is a schematic, diagrammatic representation, in flow diagram form, of an example K-fold cross-validation process 900, in accordance with at least one embodiment of the present disclosure. In block 910, the dataset is split into training and test data. In block 920, the training data is split into K folds (where K is an integer, often 5). In block 930, k−1 folds are used for training, and in block 950, the remaining fold is used for testing. In block 960, the system takes care of all transformations in the fold, ensuring that any preprocessing steps such as scaling, normalization, or encoding are applied consistently across the training and test data within each fold. This ensures that the model is trained and tested on data that has undergone the same transformations, maintaining the integrity of the validation process. In block 970, the system finds the accuracy of each fold, typically by calculation. Execution then returns to step 930 until all folds have been tested.

Block 940 is a visual representation of the K-fold validation process, wherein, in a first step fold 1 is used for testing and folds 2-5 are used for training. In a second step, fold 2 is used for testing and folds 1 and folds 3-5 are used for training. In a third step, fold 3 is used for testing and folds 1-2 and 4-5 are used for training. In a fourth step, fold 4 is used for testing and folds 1-3 and 5 are used for training. In a fifth step, fold 5 is used for testing and folds 1-4 are used for training.

FIG. 10 is a schematic, diagrammatic representation of a stacked heterogeneous machine learning model 1000, in accordance with at least one embodiment of the present disclosure. The model 1000 begins with e.g., five base models or Level 0 models 1010, 1020, 1030, 1040, and 1050, each defining functions f₁(x), f₂(x), f₃(x), f₄(x), and f₅(x), respectively. The outputs of these base models are predictions p₁, p₂, p₃, p₄, and p₅ respectively. Next, a meta model, ensemble model, stacked model, or Level 1 model 1060 is defined as y=α+β1*p₁+β2*p₂+β3*p₃+β4*p₄+β5*p₅+Error, wherein α is a constant, β₁-β₅ are the respective weights applied to the base models or Level 0 models 1010-1050, and y is the prediction made by the meta model 1060.

Next, the stacked heterogeneous machine learning model 1000 defines the contribution for each parameter or feature in the final prediction, reflecting the importance of that parameter to the result. For a given feature f1, the contribution is defined as:

$$Contribution\_f 1 = {f}_{1}^{( 1 )} * w 1 + {f}_{1}^{( 2 )} * w 2 + {f}_{1}^{( 3 )} * w 3 + {f}_{1}^{( 4 )} * w 4 + {f}_{1}^{( 5 )} * w 5$$

### Where,

f₁⁽¹⁾, f₁⁽²⁾, f₁⁽³⁾, f₁⁽⁴⁾, f₁⁽⁵⁾: Weights of features 1 across all Level-0 model w1, w2, w3, w4, w5: Weights of each model

The process of determining the weights β1-5 and w1-w5 is described below.

### Part 1:

For simplicity, assume there are only two models in the ensemble: m₁, m₂.

Build explanation models for each of the models separately. Call them models e₁, e₂.

On top of that, also build an explanation model for the ensemble model. Call it model E.

Models e₁ and e₂ are the crude dataset features. This yields weights:

$${f}_{1}^{( 1 )} , … , {f}_{n}^{( 1 )} and {f}_{1}^{( 2 )} , … , {f}_{n}^{( 2 )}$$

corresponding to one weight per feature in each model.

Model E will explain the relative contribution (weights) of each of the models m₁, m₂. Call these w₁, w₂.

Then the explanation of each transaction will be a linear combination of the weights of the models and the features. For example, to determine how much the feature f₁ contributed, the system can calculate:

$${Contribution\_f}_{1} = {f}_{1}^{( 1 )} {w}_{1} + {f}_{1}^{( 2 )} {w}_{2}$$

### Part 2:

Weights of the stacked Model

Decide the model evaluation criteria precision, f-score, variability

In an example, the criteria are precision and variability.

Provide the weight for each criterion based their importance:

For example: Precision (e.g., mean) has 60% weightage while variability (e.g., standard deviation) has 40% weightage

Assign a rank to each model based on their respective criteria, such that higher precision results in higher ranking, and lower variability also results in higher ranking. Next, calculate the weighted ranking using below approach:

$$Wi = ( ( w 1 * R 1 + w 2 * R 2 ) ) / ( R 1 + R 2 ) where ,$$

w1: precision weight: 0.6, w2: variability weight: 0.4
R1: precision rank of given model, R2: variability rank of given model

TABLE 1
Ranking and Weighting of Different Model Types

| Model | Mean | Std | Rank-Mean | Rank-Std | Weight |
|---|---|---|---|---|---|
| Weight | | | 0.6 | 0.4 | |
| XGB | 0.776 | 0.205 | 3 | 2 | 0.52 |
| KNN | 0.773 | 0.166 | 2 | 3 | 0.48 |
| CART | 0.761 | 0.139 | 1 | 4 | 0.44 |
| SVM | 0.783 | 0.253 | 4 | 1 | 0.56 |
| RF | 0.784 | 0.138 | 5 | 5 | 0.50 |

In order to identify the weights for each criterion (e.g., mean and standard deviation), the system uses the following process:

### Weight Parameter Optimization

Get the predicted outcome from different heterogenous model.

Define the grid search for precision weight parameter [0.1, 0.2 . . . 0.9].

Define the grid search for variability weight parameter [0.1, 0.2 . . . 0.9].

Calculate the mean log-loss of ensemble model for each grid search combination

Finalize the weight where the minimum log-loss occurs.

TABLE 2
Defining Weights by Minimizing Log-Loss

| Level 1 Model | Weight | Weight |
|---|---|---|
| Mean-Log Loss | parameter -2 | parameter - 1 |
| 0.1 | 0.2 | 0.5 |
| 0.12 | 0.6 | 0.3 |
| 0.08 | 0.6 | 0.4 |
| 0.13 | 0.4 | 0.7 |
| 0.09 | 0.3 | 0.9 |

In this manner, the meta model or Level 1 model can be defined, based on the outputs of the Level 0 models, without the need for a training process per se. However, in other embodiments, the weights applied to each Level 0 model in the Level 1 model may be determined through a training process, as will be familiar to a person of ordinary skill in the art. It is noted that an accurate training process may arrive at the same or very similar weights as the process described above.

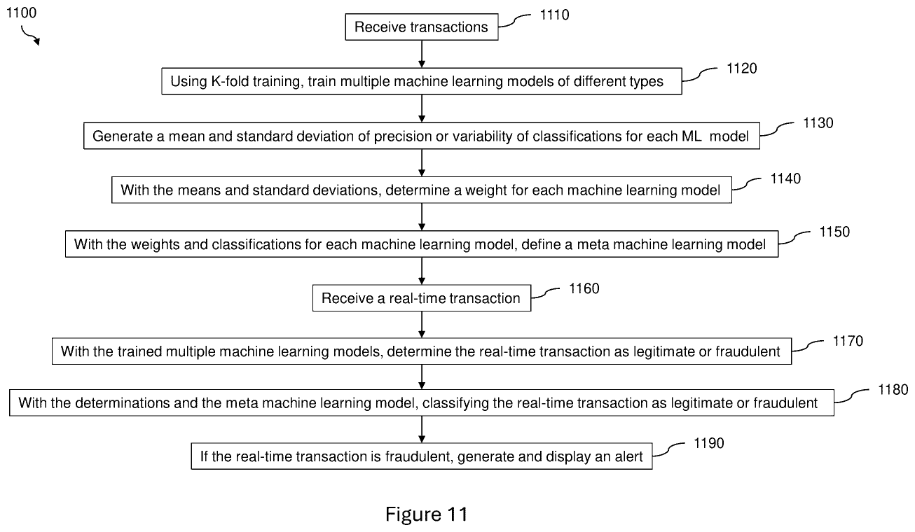

FIG. 11 shows a flow diagram of an example stacked heterogeneous machine learning method according to at least one embodiment of the present disclosure. It is understood that the steps of method 1100 may be performed in a different order than shown in FIG. 11, additional steps can be provided before, during, and after the steps, and/or some of the steps described can be replaced or eliminated in other embodiments. One or more of steps of the method 1100 can be carried by one or more devices and/or systems described herein, such as components of the system 100 and/or processor circuit 250.

In step 1110, the method 1100 includes receiving a plurality of past transactions (e.g., from an integrated fraud management storage database, possibly including static customer data from a customer database). Execution then proceeds to step 1120.

In step 1120, the method 1100 includes training multiple machine learning models of different types using K-fold training. Execution then proceeds to step 1130.

In step 1130, the method 1100 includes generating a mean and standard deviation of precision or variability for the classifications produced by each of the machine learning models. Execution then proceeds to step 1140.

In step 1140, the method 1100 includes determining a weight for each machine learning model using the means and standard deviations according to the methods described above in FIG. 10. Execution then proceeds to step 1150.

In step 1150, the method 1100 includes defining a meta machine learning model by using the weights and classifications for each of the multiple machine learning models, according to the methods described above in FIG. 10. Execution then proceeds to step 1160.

In step 1160, the method 1100 includes receiving a real-time transaction. Execution then proceeds to step 1170.

In step 1170, the method 1100 includes, with each of the multiple machine learning models, determining whether the real-time transaction is legitimate or fraudulent. This may for example involve each model generating a risk score between 0 and 1, with 1 representing the highest level of risk. Execution then proceeds to step 1180.

In step 1180, the method 1100 includes feeding these determinations to the meta machine learning model, which then classifies the real-time transaction as legitimate or fraudulent, e.g., by producing a risk score between 0 and 1 or between 0 and 100. Execution then proceeds to step 1190.

In step 1190, the method 1100 includes, if the transaction is fraudulent (e.g., if the risk score exceeds a threshold value such as 40% or 75%), generating an alert and displaying it to a user such as a fraud analyst. The method 1100 is now complete.

Flow diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information (whether static or dynamically updated) that is not otherwise available.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, to avoid impeding legitimate commerce, the determination of whether a real-time transaction is legitimate or fraudulent must generally be made within five seconds of the transaction being requested.

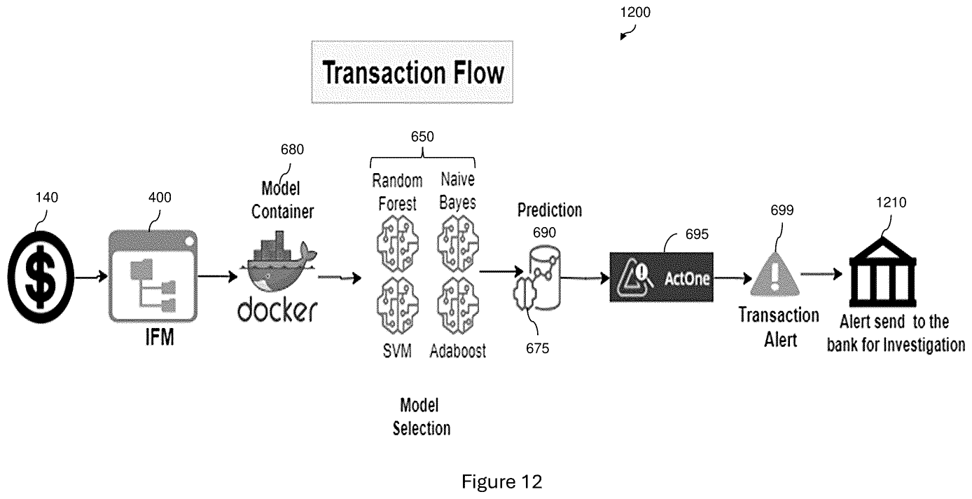

FIG. 12 is a schematic, diagrammatic representation, in block diagram form, of an example transaction flow 1200, in accordance with at least one embodiment of the present disclosure. In the example shown in FIG. 12, a real-time transaction 140 is received by an integrated fraud management system 400, and passed to a model container 680.

Traditional machine learning model deployment often involves installing dependencies and libraries on a server, which can be cumbersome and time-consuming. This block highlights the use of a containerization technology such as Docker. Docker allows packaging the chosen machine learning model, along with all its dependencies (libraries, frameworks) into a lightweight, portable unit called a container. Benefits of containerization include:

Isolation: Each container may be run in isolation from other processes on the system, ensuring the model's environment remains consistent and predictable regardless of the underlying server configuration. Subsets of containers may also be run in isolation from other processes.

Portability: Docker containers are self-contained, making it easy to deploy the model across different environments (development, testing, production) without worrying about compatibility issues.

Scalability: Containers are lightweight and can be easily scaled up or down based on processing demands. This allows for efficient resource utilization, especially when handling high volumes of real-time transactions.

As mentioned earlier, the diagram might represent a scenario where data is segmented into clusters based on customer characteristics. In such a case, a separate machine learning model might be trained for each cluster.

Containerization of the Cluster Model: If clustering is used, this block signifies that the clustering model object, along with its dependencies, would also be containerized using Docker. This ensures both the clustering logic and the specific machine learning models for each cluster are packaged and deployed together.

The model container may include multiple machine learning models 650. This block emphasizes that all the chosen machine learning models, whether it's a single selected model, multiple models for different scenarios, or multiple models feeding a meta model 675, are containerized using a tool such as Docker. This creates portable and isolated units for each model, simplifying deployment and management.

### Deployment in Production:

Orchestration Tools: Once the models are containerized, they are deployed in a production environment. This likely involves using container orchestration tools like Kubernetes that manage the lifecycle of the containers, ensuring they run smoothly and are scaled appropriately to handle real-time traffic.

The containerized machine learning model(s) then produce a prediction 690, such as a risk score between 1 and 0, with 1 indicating a 100% chance that the transaction is fraudulent, and 0 indicating a 0% chance that the transaction is fraudulent. This prediction is then passed to a policy manager 695, such as NICE Actimize ActOne, which determines whether or not to generate an alert 699 for the transaction. This determination may for example be made based on whether the computed risk score exceeds a defined threshold.

In an example, all transactions and their associated risk scores are sent to ActOne, which is a One-for-All Intelligent Investigation Platform. Managing risk and investigations is more complex and costlier than ever before, so organizations are demanding a new approach to alert and case management that enables their analysts and investigators to reduce investigation time, while improving decision making. NICE Actimize's ActOne fundamentally transforms financial crime investigations by introducing intelligent automation and visual storytelling for speed and accuracy. Intelligent automation saves times by enabling virtual workforce of robots to collaborate with human investigators, while visual storytelling uncovers more risks by showing relationships between entities, alerts and cases in a visual manner. NICE Actimize ActOne's policy manager allows users to create rules using an intuitive user interface. The platform's advanced analytics identifies hidden relationships and explores networks to identify risks, ensuring a comprehensive understanding of fraud patterns. NICE Actimize ActOne's policy manager takes client configurability a step further by enabling the definitions of thresholds that determine how aggressively the system flags transactions for review, thus striking a balance between risk mitigation and customer experience.

If an alert 699 is generated, then in a sending step 1210 the alert is sent to the financial institution for investigation. Depending on the severity of the score and pre-configured rules, the system might automatically take actions like:

Allow Transaction: This represents the ideal scenario where the score is below the threshold, indicating a low fraud risk. The transaction is processed and allowed to proceed without any restrictions.

Decline Transaction: This occurs when the score is significantly above the threshold, suggesting a high likelihood of fraud. The system automatically declines the transaction to prevent potential financial losses.

Delay Transaction: This happens for transactions with scores exceeding a specific level (but perhaps not as high as the automatic decline threshold). The transaction is flagged as suspicious, but the system might hold it for a set period to allow a fraud analyst to review the details before making a final decision.

All transactions whose score is beyond a certain threshold may result in an alert getting generated.

After alert is received by the FI, the FI needs to configure automated steps which will utilize the alert score and other simple relevant features for the bank such as the amount of the transaction, from where the transaction is triggered etc. Based on that, one out of the above steps may be taken by the FI.

Here is an example of how client-configured thresholds can work:

### Feature-Based Risk Assessment:

ActOne evaluates transactions based on a set of pre-defined features, such as:

Transaction amount: Smaller transactions like a $10 ATM withdrawal might be considered less risky by default.

Transaction location: Transactions originating from a familiar ATM location used by the customer frequently would be less suspicious than those from a high-risk geographic area.

Customer behavior: The system considers the customer's historical transaction patterns. A small withdrawal from an ATM might be normal for a customer who typically makes small, frequent withdrawals, but highly unusual for someone who usually makes large purchases.

Device characteristics: Transactions from unrecognized devices or those known to be associated with fraudulent activity would raise a red flag.

FIs can use final model score to delay/stop/allow transaction as demonstrated above:
1. IFM generates a final score for the deployed model per the transaction type.
2. In the Policy Manager, the user can set desired score threshold to stop/allow/delay transactions.
3. In the Policy Manger rules for the deployed transaction type, the user can for example define 3 rules for all scenarios.

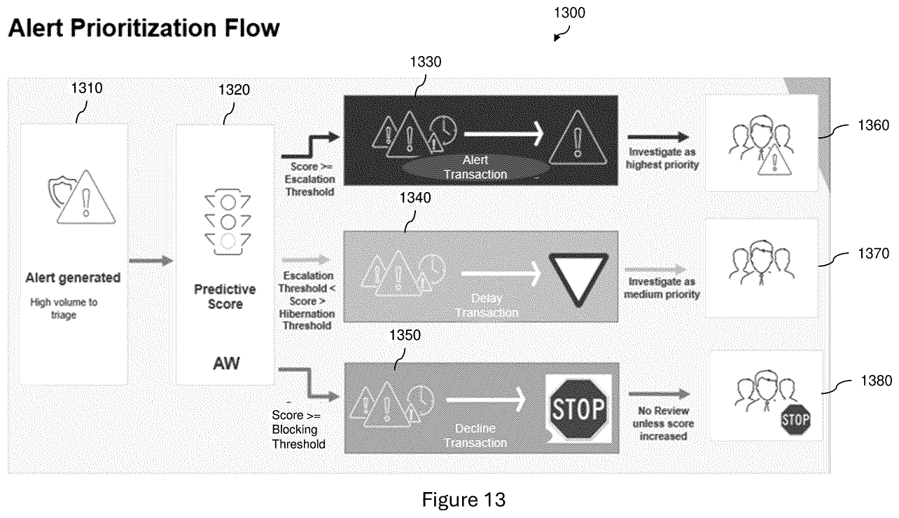

FIG. 13 is a schematic, diagrammatic representation of an alert prioritization flow 1300, in accordance with at least one embodiment of the present disclosure. If an alert 1310 is generated, then one of three automated actions may be taken by the system based on the predicted risk score 1320 for the transaction.

In step 1350, if the final transaction risk score is greater than a blocking threshold score, the transaction is stopped/declined/blocked, and in a step 1380, no review is taken unless the score is reduced below the threshold.

In step 1340, if the final transaction risk score is within a suspicious range (e.g., between 0.5 to 0.7 out of 1.0, or between 50-70 out of 100) then delay the transaction by a set amount and, in a step 1370, investigate the transaction as a medium priority.

In step 1330, if the final transaction risk score exceeds an escalation threshold but is less than the blocking threshold, then in step 1360, investigate the transaction as the highest priority.

### Allow Transaction:

Based on client configured threshold and relevant features values it will be decided if the customer transaction needs to be allowed. For example, a user might set a threshold for the transaction amount, such as $10. Transactions below this amount would be considered lower risk, even if the alert score generated by the system is slightly above a pre-defined threshold (Threshold 1). In this scenario, the system would likely allow the transaction to proceed despite the alert. This allows the system to prioritize resources by focusing on higher-risk transactions that exceed the configured thresholds.

### Delay Transaction:

In the above example for an ATM transaction done by the user if, the score is the same but the transaction amount is very high, such as $1,000, then it may be considered very important and need to be investigated. A high-value transaction, like a $1,000 ATM withdrawal, is likely more important to the customer compared to a small withdrawal. A fraudulent high-value withdrawal, or a succession of temporally-proximate moderate-value withdrawals, could result in significant financial loss for the customer. Large cash withdrawals on their own or more moderate size withdrawals in combination can also be a red flag for money laundering activities. By monitoring such ATM transactions, institutions can help mitigate the risk of being used for illicit purposes. Hence, in such cases, the transaction may be delayed, e.g., until a human user can review the data and verify or approve the questioned transaction.

### Decline Transaction:

In a scenario where the threshold is very high, e.g., in absolute terms, relative terms, or based on a pre-set threshold by a user, then in such cases transactions are declined immediately. For example, the transaction amount might be astronomically high compared to the customer's typical spending patterns. Imagine a customer with an average monthly spend of $100 attempting to withdraw $10,000 from an ATM. The transaction might be accompanied by other red flags, such as originating from a known blacklisted location or involving a recently compromised account. This threshold signifies transactions that are considered to be very high risk, exceeding the bank's usual tolerance level. When a transaction surpasses this “very high” risk threshold or blocking threshold, the system may automatically decline it without delay. This immediate action minimizes the potential for financial loss in case of fraudulent activity.

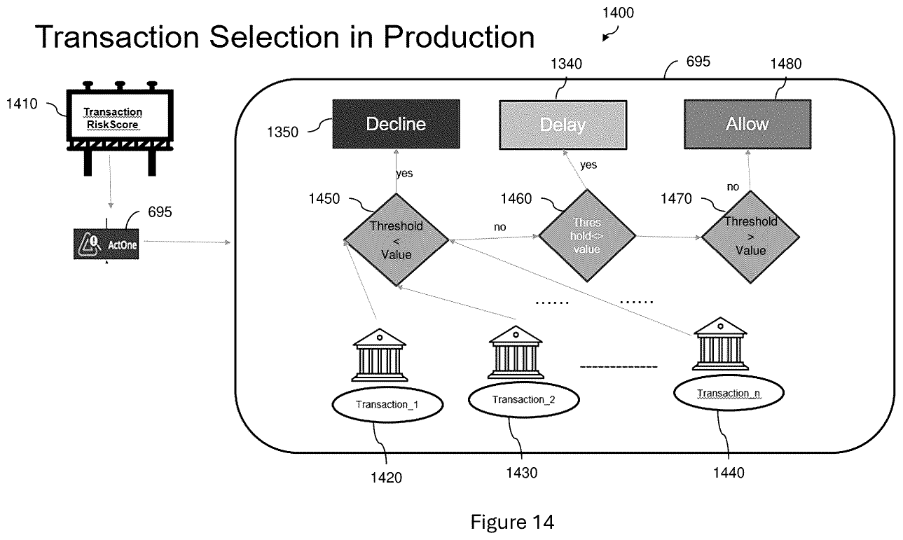

FIG. 14 is a schematic, diagrammatic representation of a transaction response selection 1400 in a production environment, in accordance with at least one embodiment of the present disclosure. Each transaction 1420, 1430, 1440 is assigned a Transaction Risk Score 1410, likely based on various factors and algorithms, including but not necessarily limited to the stacked heterogeneous machine learning model. The policy manager 695 then processes this risk score 1410 against predefined thresholds.

The decision flow is represented by a series of threshold checks:

In step 1450, if the risk score is above a high threshold, then in step 1350, the transaction is declined or blocked.

In step 1460, if the risk score is between a medium and high threshold, then in step 1340 the transaction is delayed for further investigation.

In step 1470, if the risk score is below a low threshold, then in step 1480, the transaction is allowed to proceed.

This process is applied to all transactions (Transaction_1, Transaction_2, . . . , Transaction_n).

In an example, for Bank A with defined thresholds:

If transactionRiskScore>80, then the transaction is Declined.

If 40<transactionRiskScore≤80, then the transaction is Delayed for investigation.

If transactionRiskScore≤40, then the transaction is Allowed to proceed.

This tiered approach allows the bank to automatically handle transactions based on their perceived risk level, balancing security with customer convenience. Higher-risk transactions are scrutinized more closely or declined, while lower risk transactions are processed more quickly.

It is noted that transaction risk scores 1410 are more accurately predicted using the stacked heterogeneous machine learning model or meta model than they are with any of the base models or Level 0 models feeding into it, as shown in Table 3:

TABLE 3
Results

| Model | Mean Accuracy | Std |
|---|---|---|
| XGB | 0.776 | 0.205 |
| KNN | 0.773 | 0.166 |
| CART | 0.761 | 0.139 |
| SVM | 0.783 | 0.253 |
| RF | 0.784 | 0.138 |
| Stacking (meta model) | 0.803 | 0.132 |

Where Accuracy is measured using business metrics like detection rate (DR) and value detection rate (VDR) along with other statistical metrics like precision, area under the curve (AUC), and F1 score.

The above test result shows that the system bets better (2.7% higher) performance when stacking multiple models as compared to the existing standalone XGB model, and 1.9% better performance than the best model in the ensemble (in this example, the Random Forest (RF) model). The stacked heterogeneous machine learning model also provides a standard deviation of just 0.132—a 4.5% variability improvement over the Random Forest model and a 55% variability improvement vs. the XGBoost model. Such improvements are financially meaningful, providing not only greater prediction accuracy but also greater confidence in the prediction results, and thus represent a clear, measurable improvement over the existing art of fraud detection.

Thus, as will be readily appreciated by those having ordinary skill in the art after becoming familiar with the teachings herein, the stacked heterogeneous machine learning model advantageously provides more accurate, less variable risk scores than any individual machine learning model evaluated.

A number of variations are possible on the examples and embodiments described above. For example, different base models or numbers of base models could be used than those described herein, without departing from the spirit of the present disclosure. The technology described herein may be applied to anomaly detection methods outside of the banking sector, including but not limited to healthcare for detecting unusual patient records, cybersecurity for identifying potential security breaches, manufacturing for spotting defects in production lines, and retail for detecting unusual purchasing patterns.

Accordingly, the logical operations making up the embodiments of the technology described herein are referred to variously as operations, steps, blocks, objects, elements, components, or modules. Furthermore, it should be understood that these may occur, or be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the stacked heterogeneous machine learning model. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the stacked heterogeneous machine learning model as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to automatically detect fraudulent transactions, the system comprising:
a fraud management computer system having a processor and a non-transitory computer readable medium operably coupled thereto, the fraud management computer system comprising a transactions database, the non-transitory computer-readable medium comprising a plurality of instructions stored in association therewith that are accessible to, and executable by, the processor, to perform operations which comprise:
over a first period of time, with the transactions database, receiving a plurality of transactions, each transaction comprising a plurality of features, wherein some of the transactions are legitimate and some of the transactions are fraudulent;
with the plurality of transactions and a K-fold training module, training a heterogeneous plurality of machine learning models to classify the transactions as legitimate or fraudulent, wherein each machine learning model of the heterogeneous plurality of machine learning models is of a different type than other machine learning models of the heterogeneous plurality of machine learning models,
wherein each respective machine learning model of the heterogeneous plurality of machine learning models generates a respective weight for each feature of the plurality of features;
wherein the K-fold training module generates, for each respective machine learning model of the heterogeneous plurality of machine learning models, a mean and a standard deviation, wherein the mean and the standard deviation are of precision values or variability values of the respective machine learning model;
with the mean and the standard deviation for each respective machine learning model of the heterogeneous plurality of machine learning models, determining a weight of the respective machine learning model;
with the weights for each respective machine learning model, and the classifications made by each respective machine learning model, defining a meta machine learning model to classify the transactions as legitimate or fraudulent;
receiving a real-time transaction;
with the trained machine learning models of the heterogeneous plurality of machine learning models, generating a plurality of determinations of whether the real-time transaction is legitimate or fraudulent;
with the meta machine learning model and the plurality of determinations, classifying the real-time transaction as legitimate or fraudulent; and
if the real-time transaction is fraudulent, generating an alert for the real-time transaction; and
displaying the alert to a user.

2. The system of claim 1, wherein the operations further comprise, with the weights of the respective features for each respective machine learning model of the heterogeneous plurality of machine learning models, and the weights of the respective machine learning models, determining a contribution of each feature of the plurality of features to the classification made by the meta machine learning model.

3. The system of claim 1, wherein determining the weight of the respective machine learning model involves minimizing a log-loss of the meta machine learning model.

4. The system of claim 1, wherein the heterogeneous plurality of machine learning models includes at least one of a random forest model, a Naïve Bayes model, a support vector machine, a gradient boosting model, an Adaboost model, a K-Nearest-Neighbor model, an XGBoost model, a classification and regression tree (CART) model, or a decision tree model.

5. The system of claim 1, wherein the heterogeneous plurality of machine learning models is selected from a larger plurality of machine learning models.

6. The system of claim 5, wherein the selection is a selection of machine learning models of the larger plurality that have higher accuracy than an average accuracy of the larger plurality of machine learning models in making the plurality of determinations of whether the real-time transaction is legitimate or fraudulent.

7. The system of claim 6, wherein the accuracy is determined by an area-under-curve (AUC), F1, detection rate, or value detection rate, or a combination thereof.

8. The system of claim 1, wherein the heterogeneous plurality of machine learning models comprises at least five (5) machine learning models.

9. The system of claim 1, wherein the operations further comprise performing at least one of data filtration, data cleaning, exploratory data analysis, fraud enrichment, feature engineering, or feature selection for the plurality of transactions, or a combination thereof.

10. The system of claim 1, wherein the K-fold training module uses five (5) folds.

11. A computer-implemented method, comprising, with a fraud management computer system having a processor and a non-transitory computer readable medium operably coupled thereto, the fraud management computer system comprising a transactions database:
over a first period of time, with the transactions database, receiving a plurality of transactions, each transaction comprising a plurality of features, wherein some of the transactions are legitimate and some of the transactions are fraudulent;
with the plurality of transactions and a K-fold training module, training a heterogeneous plurality of machine learning models to classify the transactions as legitimate or fraudulent, wherein each machine learning model of the heterogeneous plurality of machine learning models is of a different type than other machine learning models of the heterogeneous plurality of machine learning models,
wherein each respective machine learning model of the heterogeneous plurality of machine learning models generates a respective weight for each feature of the plurality of features;
wherein the K-fold training module generates, for each respective machine learning model of the heterogeneous plurality of machine learning models, a mean and a standard deviation, wherein the mean and the standard deviation are of precision values or variability values of the respective machine learning model;
with the mean and the standard deviation for each respective machine learning model of the heterogeneous plurality of machine learning models, determining a weight of the respective machine learning model;
with the weights for each respective machine learning model, and the classifications made by each respective machine learning model, defining a meta machine learning model to classify the transactions as legitimate or fraudulent;
receiving a real-time transaction;
with the trained machine learning models of the heterogeneous plurality of machine learning models, generating a plurality of determinations of whether the real-time transaction is legitimate or fraudulent;
with the meta machine learning model and the plurality of determinations, classifying the real-time transaction as legitimate or fraudulent; and
if the real-time transaction is fraudulent, generating an alert for the real-time transaction; and
displaying the alert to a user.

12. The computer-implemented method of claim 11, further comprising:
with the weights of the respective features for each respective machine learning model of the heterogeneous plurality of machine learning models, and the weights of the respective machine learning models, determining a contribution of each feature of the plurality of features to the classification made by the meta machine learning model.

13. The computer-implemented method of claim 11, wherein determining the weight of the respective machine learning model involves minimizing a log-loss of the meta machine learning model.

14. The computer-implemented method of claim 11, wherein the heterogeneous plurality of machine learning models includes at least one of a random forest model, a Naïve Bayes model, a support vector machine, a gradient boosting model, an Adaboost model, a K-Nearest-Neighbor model, an XGBoost model, a classification and regression tree (CART) model, or a decision tree model.

15. The computer-implemented method of claim 11, wherein the heterogeneous plurality of machine learning models is selected from a larger plurality of machine learning models.

16. The computer-implemented method of claim 15, wherein the selection is a selection of machine learning models of the larger plurality that have higher accuracy than an average accuracy of the larger plurality of machine learning models in making the plurality of determinations of whether the real-time transaction is legitimate or fraudulent.

17. The computer-implemented method of claim 16, wherein the accuracy is determined by an area-under-curve (AUC), F1, detection rate, or value detection rate, or a combination thereof.

18. The computer-implemented method of claim 11, wherein the heterogeneous plurality of machine learning models comprises at least five (5) machine learning models.

19. The computer-implemented method of claim 11, further comprising:
performing at least one of data filtration, data cleaning, exploratory data analysis, fraud enrichment, feature engineering, or feature selection for the plurality of transactions, or a combination thereof.

20. The computer-implemented method of claim 11, wherein the K-fold training module uses five (5) folds.
